(19) United States
(12) Patent Application Publication
(10) Pub. No.: US 2026/0103174 A1
(43) Pub. Date: Apr. 16, 2026

(54) ELECTRO-MECHANICAL BRAKE APPARATUS AND CONTROLLING METHOD THEREOF

(71) Applicant: HYUNDAI MOBIS CO., LTD., Seoul (KR)

(72) Inventors: Hyun Woo JIN, Yongin-si (KR); Hwan Deuk KIM, Yongin-si (KR)

(73) Assignee: HYUNDAI MOBIS CO., LTD., Seoul (KR)

(21) Appl. No.: 19/331,009

(22) Filed: Sep. 17, 2025

(30) Foreign Application Priority Data
Oct. 11, 2024 (KR) 10-2024-0138204

(51) Int. Cl. B60T 8/96; B60T 7/12; B60T 8/171; B60T 8/172; B60T 8/58

(52) U.S. Cl. CPC B60T 8/96; B60T 7/12; B60T 8/171; B60T 8/172; B60T 8/58; B60T 2220/04; B60T 2230/04; B60T 2240/00; B60T 2250/04; B60T 2270/402; B60T 2270/406; B60T 2270/82

(57) ABSTRACT

A method for controlling an electro-mechanical brake apparatus is disclosed.

According to an embodiment of the present disclosure, provided is a method for controlling an electro-mechanical brake apparatus, including: a step of determining whether a state of a central controller is a functional failure state; a step of receiving, by a plurality of wheel controllers, wheel speed information of each wheel measured from a plurality of wheel speed sensors when it is determined that the state of the central controller is the functional failure state; a step of selectively comparing a wheel acceleration of each wheel determined based on the received wheel speed information with a plurality of wheel variable conditions; a step of determining a sign of a wheel jerk based on the wheel acceleration; a step of calculating a slope of a target clamping force based on the results of comparison with the wheel acceleration and the plurality of wheel variable conditions and a sign determination result of the wheel jerk; and a step of performing emergency braking of the vehicle by increasing or decreasing an emergency braking force based on the calculated slope of the target clamping force.

### CROSS-REFERENCE TO RELATED APPLICATION

This application claims the benefit of and priority to Korean Patent Application No. 10-2024-0138204, filed on Oct. 11, 2024, the entire disclosure(s) of which is hereby incorporated herein by reference in its entirety.

### BACKGROUND

### Technical Field

The present disclosure relates to an electro-mechanical brake apparatus and a control method thereof.

### BACKGROUND OF THE DISCLOSURE

The content described in this section merely provides background information for the present disclosure and does not constitute the related art.

An electric mechanical brake system senses the amount of a driver stepping on a pedal using a pedal simulator mounted on the pedal, and transmits the sensed amount to a central controller. The central controller calculates a braking force required for each wheel, and sends a braking command to wheel controllers disposed on each wheel. The wheel controllers receiving the braking command generate a braking force by using a motor-based electro-mechanical brake actuator mounted on each wheel. Since the electro-mechanical brake system may perform active braking and independent braking of each wheel, it is possible to perform an anti-lock braking system (ABS), a vehicle dynamic control (VDC), a traction control system (TCS), an electric parking brake (EPB), and the like.

FIG. 1 is a graph showing an emergency braking force of an electro-mechanical brake apparatus according to the related art according to a preset braking command based on a specific driving condition in the event of a failure of a central controller.

Referring to FIG. 1, an electro-mechanical brake apparatus according to the related art may not acquire vehicle information necessary for driving and braking of a vehicle when a state of a central controller is a functional failure state. Here, the vehicle information required for driving the vehicle includes a steering angle of the vehicle, a yaw rate, a speed of the vehicle, deceleration of the vehicle, and the like.

The electro-mechanical brake apparatus according to the related art may generate a preset target clamping force by using a plurality of wheel controllers to perform emergency braking when it is determined that the central controller is in functional failure state. However, a vehicle that performs emergency braking based on a preset target clamping force has a problem in that the vehicle does not respond to various driving conditions such as rain, snow, and the like in which the coefficient of friction between the tire and the road surface changes. For this reason, a wheel lock phenomenon occurs in the vehicle, and there is a problem that steering is not possible.

### SUMMARY

### Problem to Be Solved

Accordingly, the present disclosure is intended to solve these problems, and has a main purpose of increasing the braking stability of a vehicle and maintaining the possibility of steering even when the central controller is determined to be in a functional failure state.

In addition, the present disclosure mainly aims to maintain braking control robustness under various driving conditions by generating a target clamping force based on a wheel acceleration obtained based on wheel speed information.

The problems to be solved by the present disclosure are not limited to the problems mentioned above, and other problems not mentioned will be clearly understood by a person skilled in the art from the following description.

### Technical Solution

According to an embodiment of the present disclosure, provided is a method for controlling an electro-mechanical brake apparatus, including: a step of determining whether a state of a central controller is a functional failure state; a step of receiving, by a plurality of wheel controllers, wheel speed information of each wheel measured from a plurality of wheel speed sensors when it is determined that the state of the central controller is the functional failure state; a step of selectively comparing a wheel acceleration of each wheel determined based on the received wheel speed information with a plurality of wheel variable conditions; a step of determining a sign of a wheel jerk based on the wheel acceleration; a step of calculating a slope of a target clamping force based on the results of comparison with the wheel acceleration and the plurality of wheel variable conditions and a sign determination result of the wheel jerk; and a step of performing emergency braking of the vehicle by increasing or decreasing an emergency braking force based on the calculated slope of the target clamping force.

According to an embodiment of the present disclosure, provided is an electro-mechanical brake apparatus, including: a pedal sensor configured to sense an input based on a braking intention input to a brake pedal; a central controller that generates a braking command corresponding to the input received from the pedal sensor to control braking of a vehicle; a plurality of wheel controllers that receive a braking command from the central controller and are respectively disposed on a front left wheel, a right front wheel, a rear left wheel, and a rear right wheel of the vehicle to control braking based on the braking command; a plurality of wheel speed sensors configured to measure a wheel speed of each of the front left wheel, the right front wheel, the rear left wheel, and the rear right wheel; and a plurality of electro-mechanical brakes respectively connected with the plurality of wheel controllers and configured to generate a braking force of the vehicle.

### Effects of the Disclosure

According to an embodiment, an electro-mechanical brake apparatus has an effect of increasing the braking stability of a vehicle and maintaining the possibility of steering even when a central controller is judged to be in a functional failure state.

According to an embodiment, an electro-mechanical brake apparatus has the effect of maintaining braking control robustness under various driving conditions by generating a target clamping force based on wheel acceleration obtained based on wheel speed information.

### BRIEF DESCRIPTION OF THE DRAWINGS

FIG. 1 is a graph showing an emergency braking force of an electro-mechanical brake apparatus according to the related art according to a preset braking command based on a specific driving condition in the event of a failure of a central controller.

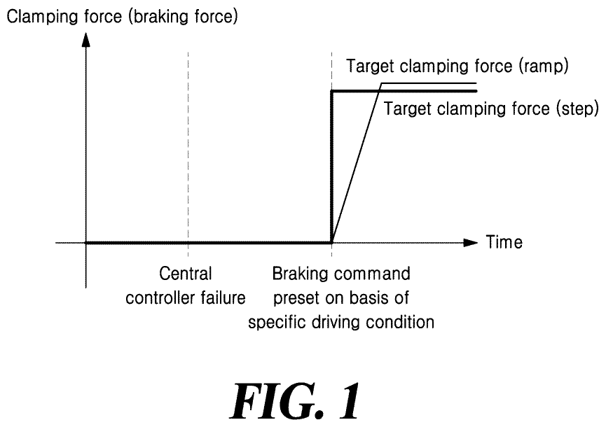

FIG. 2 is a block diagram showing a configuration of an electro-mechanical brake apparatus according to an embodiment of the present disclosure.

FIG. 3 is a graph showing a wheel speed and a wheel acceleration of an electro-mechanical brake apparatus according to an embodiment of the present disclosure.

FIG. 4 is a graph showing a wheel acceleration post-processed to determine a sign of a wheel jerk based on a wheel acceleration of an electro-mechanical brake apparatus according to an embodiment of the present disclosure.

FIG. 5 is a table showing a target clamping force slope for each section of a wheel acceleration based on a plurality of wheel variable conditions of an electro-mechanical brake apparatus according to an embodiment of the present disclosure.

FIG. 6 is a table showing a target clamping force slope determined by an electro-mechanical brake apparatus according to the first embodiment of the present disclosure by using a wheel acceleration among a plurality of wheel variable conditions.

FIG. 7 is a table showing a target clamping force slope determined by an electro-mechanical brake apparatus according to the second embodiment of the present disclosure by using a wheel acceleration and a wheel jerk among a plurality of wheel variable conditions.

FIG. 8 is a table showing a target clamping force slope determined by an electro-mechanical brake apparatus according to the third embodiment of the present disclosure using a wheel acceleration, a wheel jerk, a reference deceleration, and an initial reference deceleration among a plurality of wheel variable conditions.

FIG. 9 is a table showing a target clamping force slope determined by an electro-mechanical brake apparatus according to the fourth embodiment of the present disclosure using a wheel acceleration, a wheel jerk, a reference deceleration, an initial reference deceleration and a critical deceleration among a plurality of wheel variable conditions.

FIG. 10 is a table showing a target clamping force slope determined by an electro-mechanical brake apparatus according to the fifth embodiment of the present disclosure using a wheel acceleration, a wheel jerk, a reference deceleration, an initial reference deceleration and a critical deceleration among a plurality of wheel variable conditions.

FIG. 11 is a flowchart illustrating a control method of an electro-mechanical brake apparatus according to an embodiment of the present disclosure.

### DETAILED DESCRIPTION

Hereinafter, some embodiments of the present disclosure will be described in detail with reference to illustrative drawings. It should be noted that, in adding reference numerals to the components in each figure, the same components have the same numerals as much as possible even if they are indicated on other figures. In addition, in describing the present disclosure, when it is determined that a specific description of a related known configuration or function may obscure the gist of the present disclosure, a detailed description thereof will be omitted.

In describing the components of the embodiments according to the present disclosure, reference numerals such as first, second, i), ii), a), and b) may be used. These symbols are merely used to distinguish the components from other components, and the nature, sequence, order, and the like of the components are not limited by the symbols. In the specification, when a part “includes” or “contains” a certain component, it means that other components may be further included instead of excluding other components unless explicitly stated to the contrary. In describing the components of the present disclosure, terms such as “first,” “second,” “A,” “B,” “(a),” and “(b)” may be used. These terms are only used to distinguish the components from other components, and the nature, sequence, or order of the components is not limited by the terms.

Where a component is described as being “connected,” “coupled,” or “connected” to another component, it will be understood that the component may be directly connected or connected to the other component, but that another component may be “connected,” “coupled” or “accessed”between each component.

The terms “unit,” “module,” and the like in the specification mean a unit that processes at least one function or operation, which may be implemented by hardware or software, or a combination of hardware and software.

It should be noted that, unless otherwise specified, descriptions of one embodiment may be applied to other embodiments.

The description of the disclosure set forth below in conjunction with the appended drawings is intended to describe exemplary embodiments of the disclosure and is not intended to represent the only embodiments in which the disclosure may be practiced.

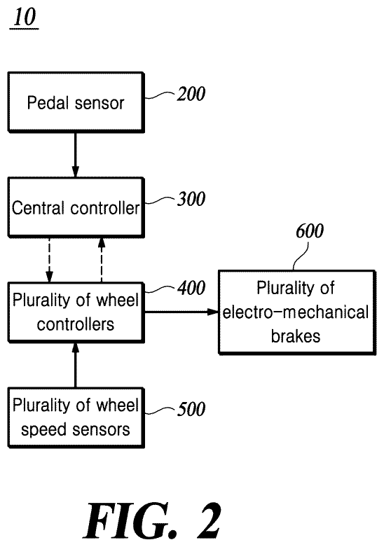

FIG. 2 is a block diagram showing a configuration of an electro-mechanical brake apparatus according to an embodiment of the present disclosure.

Referring to FIG. 2, an electro-mechanical brake apparatus 10 according to an embodiment of the present disclosure includes some or all of a pedal sensor 200, a central controller 300, a plurality of wheel controllers 400, a plurality of roller speed sensors 500, and a plurality of electro-mechanical brakes 600.

The pedal sensor 200 senses an input corresponding to a braking intention applied to the brake pedal by a driver. The pedal sensor 200 generates a pedal signal based on the sensed input. The pedal signal is a braking request signal generated by the driver applying an input to the brake pedal.

The pedal sensor 200 may be disposed adjacent to the brake pedal.

The central controller 300 receives a pedal signal from the pedal sensor 200. Based on the received pedal signal, the central controller 300 determines a braking force required for each wheel of the vehicle, and calculates a braking command to be delivered to each wheel based on the determined braking forces. Specifically, the central controller 300 calculates a braking command required for each wheel based on a front-rear wheel braking distribution ratio of the vehicle, and transmits the calculated braking command to a plurality of wheel controllers 400 to be described later.

The plurality of wheel controllers 400 generate a clamping force using each of the plurality of electrically driven brakes 600 disposed on each wheel. The plurality of wheel controllers 400 include a front left wheel controller (FL wheel controller, not shown), a front right wheel controller (FR wheel controller, not shown), a rear right wheel controller (RR wheel controller, not shown), and a rear left wheel controller (RL wheel controller, not shown).

The plurality of wheel controllers 400 may independently generate a braking command even without receiving the braking command from the central controller 300. Even when it is determined that the state of the central controller 300 is the functional failure state, the plurality of wheel controllers 400 according to an embodiment may calculate an emergency braking command required for the vehicle and perform emergency braking using the plurality of electro-mechanical brakes 600.

The plurality of wheel controllers 400 according to an embodiment may determine the emergency braking command of the vehicle by using wheel speed information received from the plurality of wheel speed sensors 500.

The plurality of wheel speed sensors 500 are disposed adjacent to each wheel. The plurality of wheel speed sensors 500 are configured to measure a wheel speed of each wheel. The plurality of wheel speed sensors 500 include a front left wheel speed sensor (not shown), a right front wheel speed sensor (not shown), a rear right wheel speed sensor (not shown), and a rear left wheel speed sensor (not shown).

The plurality of wheel speed sensors 500 are respectively connected to the front left wheel controller, the right front wheel controller, a rear right wheel controller, and a rear left wheel controller.

The plurality of wheel controllers 400 according to an embodiment may calculate a wheel acceleration of each wheel based on wheel speed information measured from the plurality of wheel speed sensors 500. The plurality of wheel controllers 400 according to an embodiment may control the emergency braking in comparison with the plurality of wheel variable conditions based on the calculated wheel acceleration.

The plurality of electro-mechanical brakes 600 include a front left wheel electro-mechanical brake (not shown), a right front wheel electro-mechanical brake (not shown), a rear right wheel electro-mechanical brake (not shown), and a rear left wheel electro-mechanical brake (not shown).

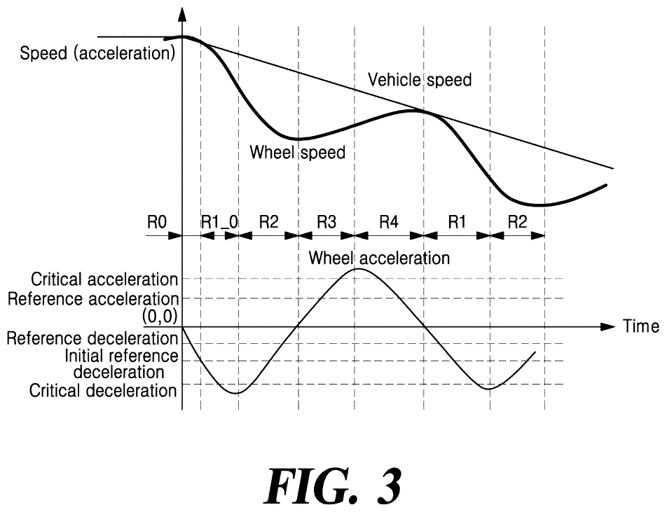

FIG. 3 is a graph showing a wheel speed and a wheel acceleration of an electro-mechanical brake apparatus according to an embodiment of the present disclosure.

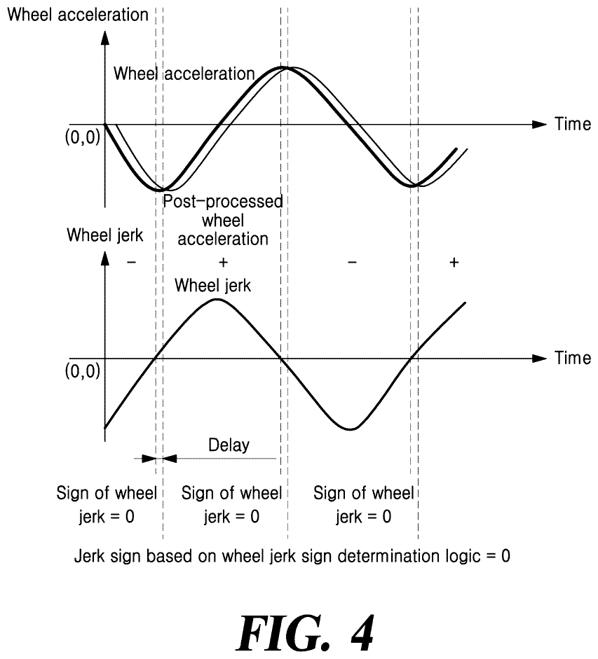

FIG. 4 is a graph showing a wheel acceleration post-processed to determine a sign of a wheel jerk based on a wheel acceleration of an electro-mechanical brake apparatus according to an embodiment of the present disclosure.

Referring to FIGS. 2 to 4, when the state of the central controller 300 is a functional failure state, the plurality of wheel controllers 400 generate an emergency braking force by using the plurality of electro-mechanical brakes 600 to reduce the speed of the vehicle. When an emergency braking force is generated, the speed of the vehicle decreases, and the wheel speed also changes. As the emergency braking force is generated, the vehicle speed may continuously decrease, but the wheel speed decreases or increases with time.

Wheel acceleration may be calculated based on the wheel speed increasing or decreasing over time. The shapes of the wheel speed curve and the wheel acceleration curve shown in FIG. 2 are merely examples and are not limited thereto. The shapes of the wheel speed curve and the wheel acceleration curve may vary depending on the type of the vehicle, the driving conditions of the vehicle, and the like.

After it is determined that the state of the central controller 300 according to an embodiment is the functional failure state, the plurality of wheel controllers 400 may compare the calculated wheel acceleration with the plurality of wheel variable conditions, determine the sign of the wheel jerk, and determine the slope of the target clamping force required for emergency braking.

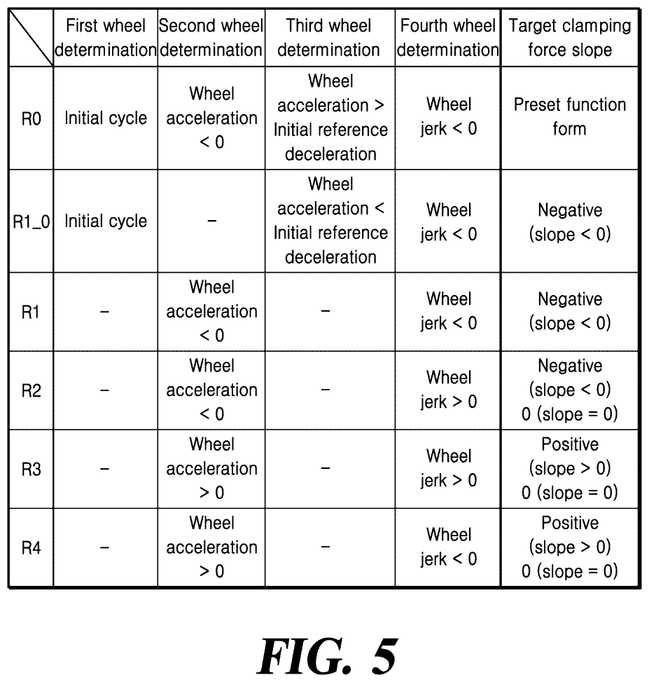

The wheel acceleration curve shown in FIG. 3 may be divided into a plurality of sections from a plurality of wheel variable conditions. Here, the plurality of sections may include some or all of the R0 section, the R1_0 section, the R2 section, the R3 section, the R4 section, the R1, and the R2 section. A specific description of each section will be given below with reference to FIG. 5.

The plurality of wheel controllers 400 according to an embodiment may determine the target clamping force slope for each section of the wheel acceleration by using some or all of the initial reference deceleration, the reference deceleration and the critical deceleration, and the reference acceleration and the critical acceleration among the plurality of wheel variable conditions. The initial reference deceleration, the reference deceleration and the critical deceleration, and the reference acceleration and the critical acceleration according to an embodiment have different values depending on the type of the vehicle and specifications of the vehicle, and may be data previously experimented according to various road conditions such as asphalt pavement, rainy road, snowy road, and the like.

In the description of the present disclosure, the target clamping force slope means an increase or a decrease in the target clamping forces. In other words, when it is determined that the slope of the target clamping force is positive, it means that the target clamping power is increased to perform emergency braking of the vehicle. Conversely, when it is determined that the slope of the target clamping force is negative, it means that the target clamping power is reduced to perform emergency braking of the vehicle. Here, the target clamping force may be increased or decreased in the form of a primary function, a secondary function, a route function, or the like depending on the driving conditions required for the vehicle, specifications and types of the vehicle, and the like.

In the wheel jerk according to an embodiment, when the vehicle is parked in the P stage, when the driver's brake pedal is turned off, that is, when the brake pedal input disappears while the driver takes his/her foot off the brake pedal, a time delay occurs until a braking force of the parking brake is generated due to the mechanical clearance. This results in an unevenness of the vehicle, which is referred to as a wheel jerk. The wheel jerk herein refers to a change in longitudinal wheel acceleration and may be expressed as jerk.

A method for determining a target clamping force slope according to one embodiment may determine the target clamping force slope according to a sign of wheel jerk and wheel acceleration.

The method for determining a sign of the wheel jerk according to an embodiment may determine a sign by differentiating wheel acceleration. However, However, the wheel jerk calculated by differentiating the wheel acceleration may have a low accuracy in the calculation result due to noise in the wheel acceleration signal. Therefore, it may be preferable to determine the sign of the wheel jerk using a post-processing of the wheel acceleration, which has high robustness, rather than a method of determining the sign of the wheel jerk by differentiating the wheel acceleration.

The post-processing of the wheel acceleration according to an embodiment may obtain an accurate wheel acceleration value by removing or reducing noise of the wheel acceleration. The post-processing of the wheel acceleration may include various forms of filtering and data processing for the wheel acceleration signal.

The post-processing of wheel acceleration according to one embodiment may use a noise reduction filter to reduce noise in wheel acceleration. Here, the noise reduction filter may include, for example, a low pass filter, a high pass filter, a band pass filter, a moving average filter, and the like. In addition, the post-processing of the wheel acceleration according to one embodiment may arbitrarily add a delay term of the wheel acceleration to generate a delay between the wheel acceleration and the post-processed wheel acceleration. Therefore, the method for determining the sign of the wheel jerk according to one embodiment may determine a highly robust wheel jerk sign by using the delay generated between the wheel acceleration and the post-processed wheel acceleration.

The method of determining the sign of the wheel jerk using the post-processing of the wheel acceleration uses a delay between signals generated by performing the above-described post-processing of wheel acceleration. Specifically, the signal of the wheel acceleration is post-processed, and the magnitude difference between the wheel acceleration and the post-processed wheel acceleration is compared with each other. Here, the delay means a time difference between a point in time at which the sign of the wheel jerk based on the wheel acceleration is 0 and a point in time at which a wheel jerk sign based on the post-processed wheel acceleration is 0. For example, when the delay magnitude between the wheel acceleration and the post-processed wheel acceleration is small, the delay may be increased for robustness of the signals.

Therefore, when the magnitudes between the wheel acceleration and the post-processed wheel acceleration are compared with each other, the sign of the wheel jerk may be judged as positive when the wheel acceleration is larger than the post-processed wheel acceleration, and the sign of the wheel jerk may be judged as negative when the wheel acceleration is smaller than the post-processed wheel acceleration.

FIG. 5 is a table showing a target clamping force slope for each section of a wheel acceleration based on a plurality of wheel variable conditions of an electro-mechanical brake apparatus according to an embodiment of the present disclosure.

Referring to FIG. 2 to FIG. 5, an electro-mechanical brake apparatus 10 according to an embodiment of the present disclosure may compare a plurality of wheel condition variables with a wheel acceleration to determine a slope of a target clamping force for each section, and determine a sign of a wheel jerk.

For example, a R0 section refers to an initial cycle section in which the state of the central controller 300 is determined to be a function failure state and a target clamping force in a preset function form is generated. For example, the target clamping force in the form of a preset function includes a form of a variable function. The preset function form may be formed based on, for example, any one of a first-order function and a second-order function in a ramp form and a step form. In addition, the preset function form has a magnitude of at least 0 or more, and may be a form in which the maximum braking force value is limited so that an excessive braking force does not occur.

In the R0 section, a first wheel determination is performed to determine whether the cycle is an initial cycle, a second wheel determination is performed, which determines whether the wheel acceleration is smaller than 0, a third wheel determination is performed which determines whether the acceleration is larger than the initial reference deceleration, and a fourth wheel determination is performed for determining whether the sign of the wheel jerk is a negative number. The R0 section means a section satisfying both the first wheel determination and the fourth wheel determination and generating a target clamping force in a preset function form.

A R1_0 section starts from a time point at which it is determined that the wheel acceleration is smaller than the initial reference deceleration of the plurality of wheel variable conditions. The R1_0 section performs a first wheel determination to determine whether it is an initial cycle, a third wheel determination to determine if the wheel acceleration is smaller than the initial reference deceleration, and a fourth wheel determination to determine the sign of the wheel jerk is negative. The slope of the target clamping force in the R1_0 section that satisfy all of the first wheel determination, the third wheel determination, and the fourth wheel determination is determined to be negative, which means an section in which the emergency braking force is reduced.

In the description of the present disclosure, the initial reference deceleration may be a wheel variable condition that is compared with a wheel acceleration value in the R0 and R1_0 sections of the wheel acceleration. For this reason, it is possible to determine the emergency braking force of the vehicle by comparing the wheel acceleration value with the reference deceleration which is not the initial reference deceleration from the R1 section in which the initial cycle has passed.

In the description of the present disclosure, the reference deceleration may have any value within a predetermined range. For example, the reference deceleration having a predetermined range may be determined within a range larger than the critical deceleration and smaller than 0 according to various road surface conditions. The reference deceleration to be described later is not limited to having a value larger than the initial reference deceleration shown in FIG. 3, and may have any value between the critical deceleration and 0.

The R1 section performs a second wheel determination to determine whether the wheel acceleration is smaller than 0, and performs a fourth wheel determination to determine whether the sign of the wheel jerk is negative. A slope of the target clamping force in the R1 section that satisfies both the second wheel determination and the fourth wheel determination is determined to be negative, and it means a section in which the emergency braking force is reduced.

The R2 section performs a second wheel determination to determine whether the wheel acceleration is smaller than 0, and performs a fourth wheel determination to determine whether the sign of the wheel jerk is positive. A slope of the target clamping force in the R2 section that satisfies both the second wheel determination and the fourth wheel determination is determined to be negative or 0, and it means a section in which the emergency braking force is reduced or maintained.

The R3 section performs a second wheel determination to determine whether the wheel acceleration is larger than 0, and performs a fourth wheel determination to determine whether the sign of the wheel jerk is positive. A slope of the target clamping force in the R3 section satisfying both the second wheel determination and the fourth wheel determination is determined to be 0, and it means a section in which the emergency braking force is maintained.

The section R4 performs a second wheel determination to determine whether the wheel acceleration is larger than 0, and performs a fourth wheel determination to determine whether the sign of the wheel jerk is negative. A slope of the target clamping force in the R4 section that satisfies both the second wheel determination and the fourth wheel determination is determined to be positive or 0, and it means a section in which the emergency braking force is increased or maintained.

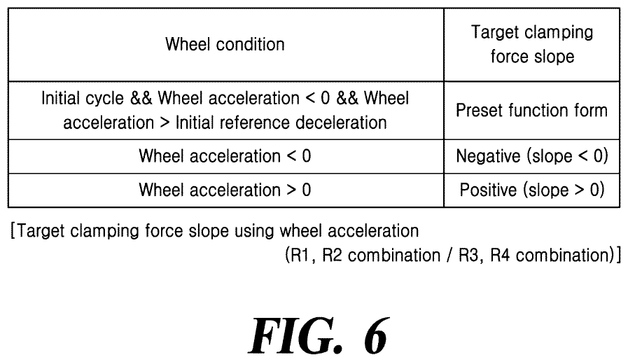

FIG. 6 is a table showing a target clamping force slope determined by an electro-mechanical brake apparatus according to the first embodiment of the present disclosure by using a wheel acceleration among a plurality of wheel variable conditions.

Referring to FIGS. 3, 5, and 6, when it is determined that the state of the central controller 300 according to the first embodiment is the functional failure state, the plurality of wheel controllers 400 calculate the wheel acceleration by using the wheel speed information of each wheel received from the plurality of wheel speed sensors 500.

The plurality of wheel controllers 400 may determine whether the wheel condition satisfies the initial cycle condition and the wheel acceleration is smaller than 0.

Referring to the wheel acceleration curve shown in FIG. 3, an section in which the initial cycle condition is satisfied, the wheel acceleration is smaller than 0, and the wheel acceleration is larger than the initial reference deceleration includes an R0 section. Therefore, the R0 section may be a section in which the target clamping force in the form of a preset function is generated to perform emergency braking.

Referring to the wheel acceleration curve shown in FIG. 3, a section in which the wheel acceleration is larger than 0 includes an R3 section and an R4 section. Therefore, the R3 section and the R4 section may be sections in which the slope of the target clamping force is determined to be positive and the emergency braking force is increased.

Referring to the wheel acceleration curve shown in FIG. 3, a section in which the wheel acceleration is smaller than 0 includes an R1 section and an R2 section. Therefore, the R1section and the R2 section may be sections in which the slope of the target clamping force is determined to be negative and the emergency braking force is reduced.

The electro-mechanical brake apparatus 10 according to the first embodiment may perform emergency braking of the vehicle by determining the slope of the target clamping force using the initial cycle condition and the determination process of whether the wheel acceleration is larger than or smaller than 0.

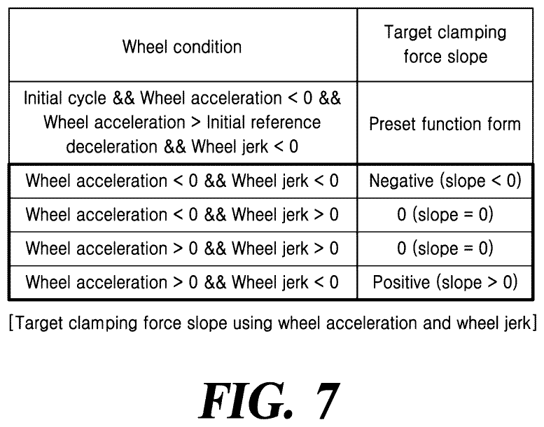

FIG. 7 is a table showing a target clamping force slope determined by an electro-mechanical brake apparatus according to the second embodiment of the present disclosure by using a wheel acceleration and a wheel jerk among a plurality of wheel variable conditions.

Referring to FIGS. 3 to 7, when it is determined that the state of the central controller 300 according to the second embodiment is the functional failure state, the plurality of wheel controllers 400 calculate the wheel acceleration by using the wheel speed information of each wheel received from the plurality of wheel speed sensors 500.

Referring to the wheel acceleration curve shown in FIG. 3, a section in which the initial cycle condition is satisfied, the wheel acceleration is smaller than 0, the wheel acceleration exceeds the initial reference deceleration, and the sign of the wheel jerk is negative includes an R0 section. Therefore, the R0 section may be a section in which the target clamping force in the form of a preset function is generated to perform emergency braking.

Referring to the wheel acceleration curve shown in FIG. 3, a section in which the wheel acceleration is smaller than 0 and the sign of the wheel jerk is negative includes an R1_0 section and an R1 section. Therefore, the R1_0 section and the R1 section may be sections in which the slope of the target clamping force is determined to be negative and the emergency braking force is reduced.

Referring to the wheel acceleration curve shown in FIG. 3, a section in which the wheel acceleration is smaller than 0 and the sign of the wheel jerk is positive includes an R2 section. Therefore, the R2 section may be a section in which the slope of the target clamping force is determined to be 0 and the emergency braking force is maintained.

Referring to the wheel acceleration curve shown in FIG. 3, a section in which the wheel acceleration is larger than 0 and the sign of the wheel jerk is positive includes an R3 section. Therefore, the R3 section may be a section in which the slope of the target clamping force is determined to be 0 and the emergency braking force is maintained.

Referring to the wheel acceleration curve shown in FIG. 3, a section in which the wheel acceleration is larger than 0 and the sign of the wheel jerk is negative includes an R4 section. Therefore, the R4 section may be an section in which the slope of the target clamping force is determined to be positive and the emergency braking force is increased.

The method for determining the target clamping force slope according to the second embodiment may generate the emergency braking force by performing further comparison with wheel variable conditions such as the reference deceleration and the wheel jerk on the basis of the method for determining the targets clamping force slopes according to the first embodiment.

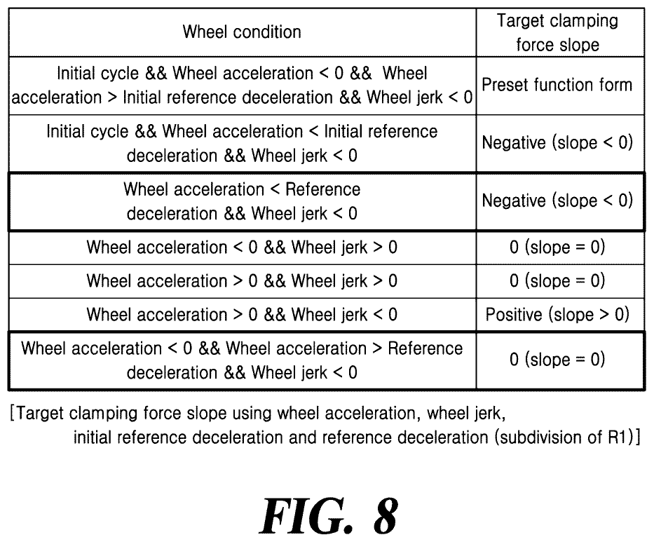

FIG. 8 is a table showing a target clamping force slope determined by an electro-mechanical brake apparatus according to the third embodiment of the present disclosure using a wheel acceleration, a wheel jerk, a reference deceleration, and an initial reference deceleration among a plurality of wheel variable conditions.

Referring to FIGS. 3 to 5 and 8, when it is determined that the state of the central controller 300 according to the third embodiment is the functional failure state, the plurality of wheel controllers 400 calculate the wheel acceleration by using the wheel speed information of each wheel received from the plurality of wheel speed sensors 500.

Referring to the wheel acceleration curve shown in FIG. 3, a section in which the initial cycle condition is satisfied, the wheel acceleration is smaller than 0, the wheel acceleration exceeds the initial reference deceleration, and the sign of the wheel jerk is negative includes an R0 section. Therefore, the R0 section may be a section in which the target clamping force in the form of a preset function is generated to perform emergency braking.

Referring to the wheel acceleration curve shown in FIG. 3, an section in which the initial cycle condition is satisfied, the wheel acceleration is smaller than the initial reference deceleration, and the sign of the wheel jerk is negative includes an R1_0 section. Thus, the R1_0section may be an section for reducing the emergency braking force.

Referring to the wheel acceleration curve shown in FIG. 3, a section in which the wheel acceleration is smaller than the reference deceleration and the sign of the wheel jerk is negative includes a section in which a reference deceleration is smaller than the R1 section. Therefore, a section smaller than the reference deceleration in the R1_0 section and the R1 section may be a section in which the target clamping force slope is determined to be negative and the emergency braking force is reduced. Although not shown in FIG. 8, in a section smaller than the reference deceleration in the R1 section, a more detailed target clamping force slope may be determined using the critical deceleration.

Referring to the wheel acceleration curve shown in FIG. 3, a section in which the wheel acceleration is smaller than 0, the wheel acceleration is larger than the reference deceleration, and the wheel jerk is negative includes a section in the R1 section that is larger than the reference deceleration. Therefore, the section larger than the reference deceleration in the R1 section may be a section in which the target clamping force slope is determined to be 0 and the emergency braking force is maintained.

Although not shown in FIG. 8, in a section larger than the reference deceleration in the R1 section, a more detailed target clamping force slope may be determined using the critical deceleration.

The electro-mechanical brake apparatus 10 according to the third embodiment may determine the slope of the target clamping force by subdividing the R1 section of the wheel acceleration, and perform emergency braking based on the determined slope of the target clamping Force.

Referring to the wheel acceleration curve shown in FIG. 3, a section in which the wheel acceleration is smaller than 0 and the sign of the wheel jerk is positive includes an R2 section. Therefore, the R2 section may be a section in which the slope of the target clamping force is determined to be 0 and the emergency braking force is maintained.

Referring to the wheel acceleration curve shown in FIG. 3, a section in which the wheel acceleration is larger than 0 and the sign of the wheel jerk is positive includes an R3 section. Therefore, the R3 section may be a section in which the slope of the target clamping force is determined to be 0 and the emergency braking force is maintained.

Referring to the wheel acceleration curve shown in FIG. 3, a section in which the wheel acceleration is larger than 0 and the sign of the wheel jerk is negative includes an R4 section. Therefore, the R4 section may be an section in which the slope of the target clamping force is determined to be positive and the emergency braking force is increased.

The method for determining the target clamping force slope according to the third embodiment may generate an emergency braking force by further subdividing the R1 section based on the method for determining the target clamping force slope according to the second embodiment.

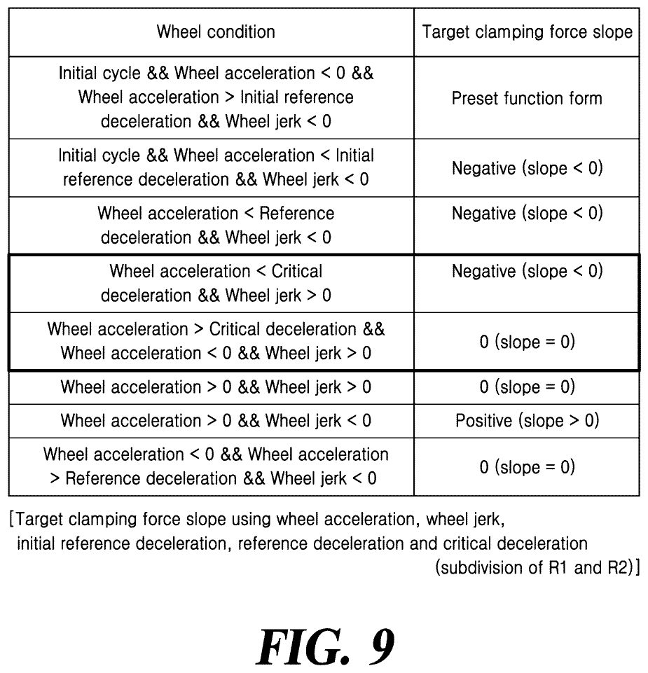

FIG. 9 is a table showing a target clamping force slope determined by an electro-mechanical brake apparatus according to the fourth embodiment of the present disclosure using a wheel acceleration, a wheel jerk, a reference deceleration, an initial reference deceleration and a critical deceleration among a plurality of wheel variable conditions.

Referring to FIGS. 3 to 5 and 9, when it is determined that the state of the central controller 300 according to the fourth embodiment is the functional failure state, the plurality of wheel controllers 400 calculate the wheel acceleration by using the wheel speed information of each wheel received from the plurality of wheel speed sensors 500.

Referring to the wheel acceleration curve shown in FIG. 3, a section in which the initial cycle condition is satisfied, the wheel acceleration is smaller than 0, the wheel acceleration exceeds the initial reference deceleration, and the sign of the wheel jerk is negative includes an R0 section. Therefore, the R0 section may be a section in which the target clamping force in the form of a preset function is generated to perform emergency braking.

Referring to the wheel acceleration curve shown in FIG. 3, an section in which the initial cycle condition is satisfied, the wheel acceleration is smaller than the initial reference deceleration, and the sign of the wheel jerk is negative includes an section R1_0. Thus, the R1_0 section may be an section for reducing the emergency braking force.

Referring to the wheel acceleration curve shown in FIG. 3, a section in which the wheel acceleration is smaller than the reference deceleration and the sign of the wheel jerk is negative includes a section of R1 that is smaller than the reference deceleration. Therefore, the R1_0 section and an section of the R1 section that is smaller than the reference deceleration may be an section in which the target clamping force slope is determined to be negative and the emergency braking force is reduced. Referring to the wheel acceleration curve shown in FIG. 3, a section in which the wheel acceleration is smaller than 0, the wheel acceleration is larger than the reference deceleration, and the wheel jerk is negative includes a section larger than the reference deceleration in the R1 section. Therefore, the section larger than the reference deceleration in the R1 section may be a section in which the target clamping force slope is determined to be 0 and the emergency braking force is maintained.

Referring to the wheel acceleration curve shown in FIG. 3, a section where the wheel acceleration is smaller than the critical deceleration and the sign of the wheel jerk is positive includes a section smaller than the critical deceleration in the R2 section. Therefore, the section smaller than the critical deceleration in the R2 section may be a section in which the target clamping force slope is determined to be negative and the emergency braking force is reduced.

Referring to the wheel acceleration curve shown in FIG. 3, a section where the wheel acceleration is larger than the critical deceleration, the wheel acceleration is smaller than 0, and the sign of the wheel jerk is positive includes a section larger than the critical deceleration in the R2 section. Therefore, the section larger than the critical deceleration in the R2 section may be a section in which the target clamping force slope is determined to be 0 and the emergency braking force is maintained. Although not shown in FIG. 9, the section larger than the critical deceleration in the R2 section may also determine a more detailed target clamping force slope using the reference deceleration.

Referring to the wheel acceleration curve shown in FIG. 3, a section in which the wheel acceleration is larger than 0 and the sign of the wheel jerk is positive includes an R3 section. Therefore, the R3 section may be a section in which the slope of the target clamping force is determined to be 0 and the emergency braking force is maintained.

Referring to the wheel acceleration curve shown in FIG. 3, a section in which the wheel acceleration is larger than 0 and the sign of the wheel jerk is negative includes an R4 section. Therefore, the R4 section may be an section in which the slope of the target clamping force is determined to be positive and the emergency braking force is increased.

The method of determining the target clamping force slope according to the fourth embodiment may generate emergency braking force by further subdividing the R2 section based on the method for determining the target clamping force slope according to the third embodiment.

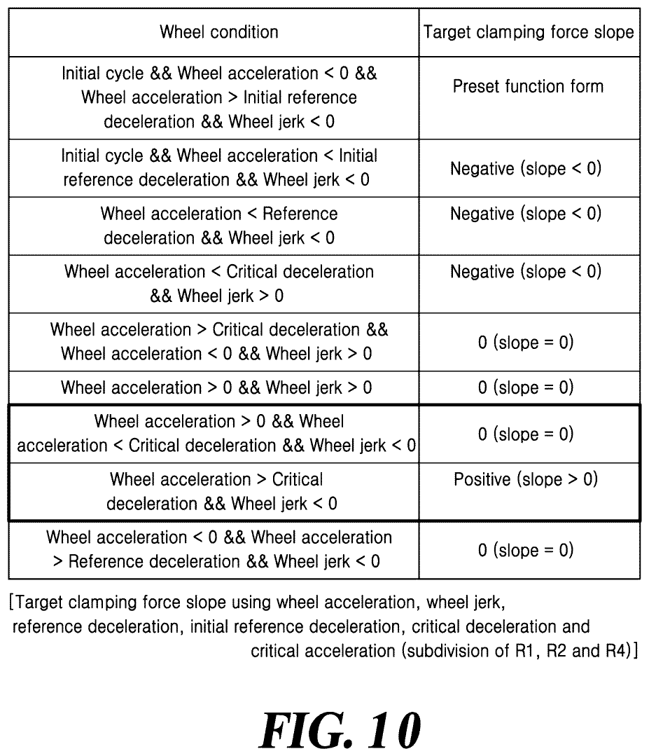

FIG. 10 is a table showing a target clamping force slope determined by an electro-mechanical brake apparatus according to the fifth embodiment of the present disclosure using a wheel acceleration, a wheel jerk, a reference deceleration, an initial reference deceleration and a critical deceleration among a plurality of wheel variable conditions.

Referring to FIGS. 3 to 5 and 10, when it is determined that the state of the central controller 300 according to the fifth embodiment is the functional failure state, the plurality of wheel controllers 400 calculate the wheel acceleration by using the wheel speed information of each wheel received from the plurality of wheel speed sensors 500.

Referring to the wheel acceleration curve shown in FIG. 3, a section in which the initial cycle condition is satisfied, the wheel acceleration is smaller than 0, the wheel acceleration exceeds the initial reference deceleration, and the sign of the wheel jerk is negative includes an R0 section. Therefore, the R0 section may be a section in which the target clamping force in the form of a preset function is generated to perform emergency braking.

Referring to the wheel acceleration curve shown in FIG. 3, an section in which the initial cycle condition is satisfied, the wheel acceleration is smaller than the initial reference deceleration, and the sign of the wheel jerk is negative includes an section R1_0. Therefore, the R1_0 section may be an section for reducing the emergency braking force.

Referring to the wheel acceleration curve shown in FIG. 3, a section in which the wheel acceleration is smaller than the reference deceleration and the sign of the wheel jerk is negative includes a section that is smaller than the reference deceleration in the R1 section. Therefore, the R1_0 section and the section that is smaller than the reference deceleration n the R1 section may be an section in which the target clamping force slope is determined to be negative and the emergency braking force is reduced. Referring to the wheel acceleration curve shown in FIG. 3, a section in which the wheel acceleration is smaller than 0, the wheel acceleration is larger than the reference deceleration, and the wheel jerk is negative includes a section that is larger than the reference deceleration in the R1 section. Therefore, the section that is larger than the reference deceleration in the R1 section may be a section in which the target clamping force slope is determined to be 0 and the emergency braking force is maintained.

Referring to the wheel acceleration curve shown in FIG. 3, a section where the wheel acceleration is smaller than the critical deceleration and the sign of the wheel jerk is positive includes a section that is smaller than the critical deceleration in the R2 section. Therefore, the section that is smaller than the critical deceleration in the R2 section may be a section in which the target clamping force slope is determined to be negative and the emergency braking force is reduced.

Referring to the wheel acceleration curve shown in FIG. 3, a section where the wheel acceleration is larger than the critical deceleration, the wheel acceleration is smaller than 0, and the sign of the wheel jerk is positive includes a section that is larger than the critical deceleration in the R2 section. Therefore, the section that is larger than the critical deceleration in the R2 section may be a section in which the target clamping force slope is determined to be 0 and the emergency braking force is maintained.

Referring to the wheel acceleration curve shown in FIG. 3, a section in which the wheel acceleration is larger than 0 and the sign of the wheel jerk is positive includes an R3 section. Therefore, the R3 section may be a section in which the slope of the target clamping force is determined to be 0 and the emergency braking force is maintained.

Referring to the wheel acceleration curve shown in FIG. 3, the section in which the wheel acceleration is larger than 0, the wheel acceleration is smaller than the critical acceleration, and the sign of the wheel jerk is negative includes a section that is smaller than the critical acceleration in the R4 section. Therefore the section that is smaller than the critical acceleration in the R4 section may be a section in which the target clamping force slope is determined to be 0 and the emergency braking force is maintained. Although not shown in FIG. 10, the section that is smaller than the critical acceleration in the R4 section may be used to determine a more detailed target clamping force slope using the reference acceleration.

Referring to the wheel acceleration curve shown in FIG. 3, a section in which the wheel acceleration is larger than the critical acceleration and the wheel jerk is negative includes a section that is larger than the critical acceleration in the R4 section. Therefore, the section that is larger than the critical acceleration in the R4 section may be a section in which the target clamping force slope is determined to be positive and the emergency braking force is increased.

In the method for determining the target clamping force slope according to the fifth embodiment, the R4 section may generate emergency braking force by further subdividing the R4 section based on the method of determining the target clamping force slope according to the fourth embodiment.

Although not shown in FIG. 6 to FIG. 10, the electro-mechanical brake apparatus 10 according to an embodiment of the present disclosure may further refine the target clamping force slope of the R3 section based on the method for determining the target clamping force slope according to the fifth embodiment to generate the emergency braking force.

For example, referring to the wheel acceleration curve shown in FIG. 3, the section in which the wheel acceleration is larger than 0, the wheel acceleration is smaller than the reference acceleration, and the wheel jerk is positive includes a section that is smaller than the reference acceleration in the R3 section. Therefore, in the section that is smaller than the reference acceleration in the R3 section, the slope of the target clamping force may be determined to be 0, and the emergency braking force may be maintained. Here, the section in which the wheel acceleration is smaller than the reference acceleration in the R3 section may determine a more refined target clamping force slope by using any specific acceleration term.

Further, referring to the wheel acceleration curve shown in FIG. 3, the section in which the wheel acceleration is larger than the reference acceleration and the sign of the wheel jerk is positive includes a section that is larger than the reference acceleration in the R3 section. Therefore, in the section that is larger than the reference acceleration in the R3 section, the slope of the target clamping force may be determined to be positive, and the emergency braking force may be increased. Here, the section in which the wheel acceleration is larger than the reference acceleration in the R3 section may use the critical acceleration to determine a more subdivided target clamping force slope.

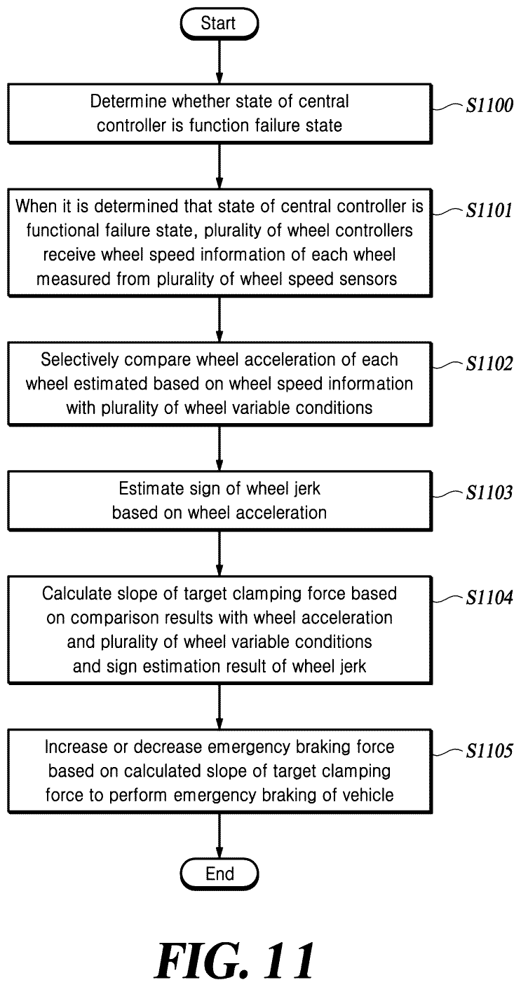

FIG. 11 is a flowchart illustrating a control method of an electro-mechanical brake apparatus according to an embodiment of the present disclosure.

Referring to FIGS. 2 to 11, it is determined whether the state of the central controller 300 is a function failure state (S1100).

When it is determined that the state of the central controller 300 is the functional failure state, the plurality of wheel controllers 400 receive wheel speed information of each wheel measured from the plurality of wheel speed sensors 500 (S1101).

The wheel acceleration of each wheel determined based on the wheel speed information of each wheel is selectively compared with a plurality of wheel variable conditions (S1102).

A sign of the wheel jerk is determined based on the wheel acceleration (S1103).

The slope of the target clamping force is determined based on the comparison results with the wheel acceleration and the plurality of wheel variable conditions and the sign determination result of the wheel jerk (S1104).

Based on the determined slope of the target clamping force, the emergency braking force is increased or decreased to perform emergency braking of the vehicle (S1105).

Various implementations of the systems and techniques described herein may be realized in digital electronic circuitry, integrated circuitry, field programmable gate array (FPGA), application specific integrated circuit (ASIC), computer hardware, firmware, software, and/or combinations thereof. These various implementations may include being implemented with one or more computer programs executable on a programmable system. The programmable system includes at least one programmable processor (which may be a special-purpose processor or may be a general-purpose processor) coupled to receive data and instructions from, and send data and instructions to, a storage system, at least one input device, and at least one output device. Computer programs (also known as programs, software, software applications or code) include instructions for a programmable processor and are stored in a “computer-readable recording medium”.

The computer-readable recording medium includes any type of recording device in which data that may be read by a computer system is stored. Such a computer-readable recording medium may be a non-volatile or non-transitory medium such as a ROM, a CD-ROM, a magnetic tape, a floppy disk, a memory card, a hard disk, a magneto-optical disk, or a storage device, and may further include a transitory medium such as a data transmission medium. In addition, the computer-readable recording medium may be distributed in a network-connected computer system, and computer-readable code may be stored and executed in a distributed manner.

Although the flowcharts/timing diagrams in this specification are described as sequentially executing respective processes, this is merely an illustrative description of the technical idea of an embodiment of the present disclosure. In other words, the flowcharts/timing diagrams are not limited to a time-series order, as those skilled in the art will be able to make various modifications and variations to the order described in the flowchart/timing diagram or to execute one or more of the processes in parallel without departing from the essential characteristics of the embodiments of the present disclosure.

The above description is merely illustrative of the technical idea of the present embodiment, and various modifications and variations will be possible to those skilled in the art without departing from the essential characteristics of the present embodiment. Therefore, the present embodiments are not intended to limit but to explain the technical idea of the present embodiment, and the scope of the technical idea of this embodiment is not limited by this embodiment. The protection scope of the present embodiment should be interpreted by the following claims, and all technical ideas falling within the scope equivalent thereto should be interpreted as being included in the scope of rights of the present embodiment.

What is claimed is:

1. A method for controlling an electro-mechanical brake apparatus, comprising:
a step of determining whether a state of a central controller is a functional failure state;
a step of receiving, by a plurality of wheel controllers, wheel speed information of each wheel measured from a plurality of wheel speed sensors when it is determined that the state of the central controller is the functional failure state;
a step of selectively comparing a wheel acceleration of each wheel determined based on the received wheel speed information with a plurality of wheel variable conditions;
a step of determining a sign of a wheel jerk based on the wheel acceleration;
a step of calculating a slope of a target clamping force based on the results of comparison with the wheel acceleration and the plurality of wheel variable conditions and a sign determination result of the wheel jerk; and
a step of performing emergency braking of the vehicle by increasing or decreasing an emergency braking force based on the calculated slope of the target clamping force.

2. The method of claim 1,
wherein the plurality of wheel variable conditions comprises:
some or all of a reference deceleration, an initial reference deceleration, a critical deceleration, a reference acceleration and a critical acceleration, which are for segmenting the wheel acceleration into sections.

3. The method of claim 2,
wherein the step of selectively comparing a wheel acceleration of each wheel determined based on the received wheel speed information with a plurality of wheel variable conditions comprises:
a step of comparing a magnitude of the wheel acceleration with some or all of the plurality of wheel variable conditions, respectively.

4. The method of claim 1,
wherein the step of determining a sign of a wheel jerk based on the wheel acceleration performs one of:
a step of differentiating the wheel acceleration to determine the sign of the wheel jerk; and
a step of determining the sign of the wheel jerk by using the post-processing of the wheel acceleration.

5. The method of claim 4,
wherein the step of determining a sign of the wheel jerk by using the post-processing of the wheel acceleration comprises:
post-processing the wheel acceleration, comparing the magnitude of the wheel acceleration with the post-processed wheel acceleration to determine the sign of the wheel jerk, wherein a noise reduction filter is used to reduce noise in the wheel acceleration, or a delay term of the wheel acceleration is added to change a delay between the wheel acceleration and the post-processed wheel acceleration.

6. The method of claim 2,
wherein the step of calculating a slope of a target clamping force based on the results of comparison with the wheel acceleration and the plurality of wheel variable conditions and a sign determination result of the wheel jerk, calculates a slope of the target clamping force by using some or all of a first wheel determination process of determining whether or not it is an initial cycle by generating an initial braking command through an input from a pedal sensor;
a second wheel determination process of determining whether a value of the wheel acceleration is larger than or smaller than 0;
a third wheel determination process of determining whether a value of the wheel acceleration is relatively large or small by comparing magnitudes of the wheel acceleration and some or all of the reference deceleration, the initial reference deceleration, the critical deceleration, the reference acceleration, and the critical acceleration, respectively;
a fourth wheel determination process of determining whether the sign of the wheel jerk is positive or negative.

7. The method of claim 6,
wherein the step of performing emergency braking of the vehicle by increasing or decreasing the emergency braking force based on the calculated slope of the target clamping force comprises:
a step of generating a target clamping force in a preset function form, and then increasing or decreasing the emergency braking force for each section according to a slope of the calculated target clamping force.

8. The method of claim 7,
wherein the target clamping force in a preset function form has any one of a variable function form and has a magnitude of at least 0 or more.

9. An electro-mechanical brake apparatus, comprising:
a pedal sensor configured to sense an input based on a braking intention input to a brake pedal;
a central controller that generates a braking command corresponding to the input received from the pedal sensor to control braking of a vehicle;
a plurality of wheel controllers that receive a braking command from the central controller and are respectively disposed on a front left wheel, a right front wheel, a rear left wheel, and a rear right wheel of the vehicle to control braking based on the braking command;
a plurality of wheel speed sensors configured to measure a wheel speed of each of the front left wheel, the right front wheel, the rear left wheel, and the rear right wheel; and
a plurality of electro-mechanical brakes respectively connected with the plurality of wheel controllers and configured to generate a braking force of the vehicle.

10. The apparatus of claim 9,
wherein the plurality of wheel controllers are configured to:
determine a target clamping force slope of the vehicle by using wheel speed information received from the plurality of wheel speed sensors, and control emergency braking of the vehicle based on the determined target clamping force slope, when it is determined that a state of the central controller is a functional failure state.
